(19) United States
(12) Patent Application Publication
(10) Pub. No.: US 2012/0047051 A1
(43) Pub. Date: Feb. 23, 2012

(54) AUTOMATED CENTRALIZED SETTLEMENT SYSTEM

(76) Inventor: Yao-Huai Chien, Taipei City (TW)

(21) Appl. No.: 12/859,291

(22) Filed: Aug. 19, 2010

(51) Int. Cl. G06Q 10/00; G06Q 30/00; G06Q 40/00

(52) U.S. Cl. 705/30; 705/34

(57) ABSTRACT

The automated centralized settlement system is coupled to various accounts receivable systems and the accounts payable systems. The automated centralized settlement system contains a receiving module, a processing module, and an output module. The receiving module is for the reception of accounts receivable data from a receiving party via an accounts receivable system, and of accounts payable data from a paying party via an accounts payable system. The processing module produces balance data from the accounts receivable and payable data, and the balance data is output by the output module.

### (a) TECHNICAL FIELD OF THE INVENTION

The present invention generally relates to a system for centralized and automated processing settlements, and more particular to an automated centralized settlement system applicable to an Enterprise Resource Planning (ERP) system.

### (b) DESCRIPTION OF THE PRIOR ART

Running a business would produce accounts receivable and accounts payable and these accounts receivable and payable need to be balanced. Accounts receivable (A/R) are accounting transactions dealing with the billing of a customer for goods and services the customer has ordered. When payment from the customer is actually received, an A/R entry in the accounting system should be settled. On the other hand, accounts payable (A/P) are accounting transactions dealing with the debt owed to a supplier for goods and services ordered from the supplier.

Conventionally, to balance accounts receivable, an accountant, based on the information about a customer check or wire transfer, queries the A/R entries already created in the accounts receivable system, selects one or more entries, calculates manually the entries' amounts, and then enters the various amounts to settle these entries.

On the other hand, conventionally there are two ways to balance accounts payable. One is to settle the entries one by one. The accounts queries the A/P entries already created but still open according to the supplier's invoice or purchase receipt, manually selects the entries to be settled, enters the amount to pay, and the accounts payable system calculates the total amount to pay. The other way is to settle the entries periodically where, at the end of a fixed period such as a month, all open A/P entries for a supplier are summarized and the net amount to pay is manually calculated.

The conventional settlement processes described above are not only troublesome but also prone to errors. The other disadvantages of the manual settlement process are as follows. First, conventionally, a receiving party would send a collection note by email or post mail to a paying party. When the parties have differences in terms of the details, they need to communicate over the phone or through emails. After the details are agreed by both parties, the paying party will make the payments one by one. Usually a lengthy checking and communication process is inevitable.

Secondly, the paying and receiving parties usually have difficulty in knowing the real-time payment and reception status. Moreover, the checking processes are not documented and disputes might occur in the future. In addition, after checking, it is not uncommon that the accounts are not immediately settled, leading to accounting errors.

Further more, when the business grows, the foregoing disadvantages become even more severe as the number of customers and suppliers increase.

### SUMMARY OF THE INVENTION

An automated centralized settlement system is provided herein, which is a common platform among an enterprise's organization units and agents where all accounts receivable and payable data is centralized and settled so that error rate and cost of manual processing could be significantly reduced. Further more, as all settlements are conducted and all data is stored in a single platform, a system administrator could monitor transactions among the organization units and agents, and examine history records.

The automated centralized settlement system is coupled to various accounts receivable systems and the accounts payable systems. The automated centralized settlement system contains a receiving module, a processing module, and an output module. The receiving module is for the reception of accounts receivable data from a receiving party via an accounts receivable system, and of accounts payable data from a paying party via an accounts payable system. The processing module produces balance data from the accounts receivable and payable data, and the balance data is output by the output module.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic diagram showing an automated centralized settlement system according to an embodiment of the present invention.

FIG. 2 is a schematic diagram showing the details of a processing module of the automated centralized settlement system of FIG. 1.

FIG. 3 is a schematic diagram showing an automated centralized settlement system according to another embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

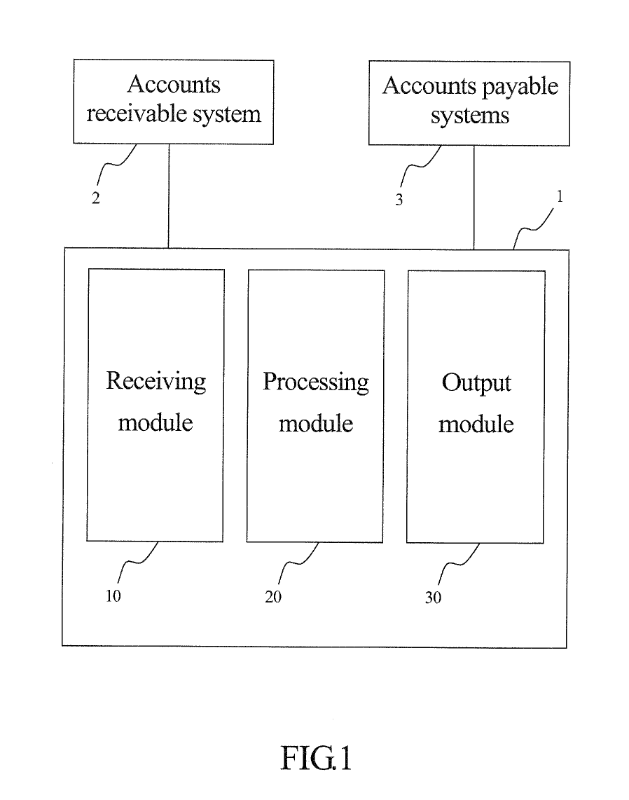

FIG. 1 is a schematic diagram showing an automated centralized settlement system according to an embodiment of the present invention. As illustrated, the automated centralized settlement system 1 contains a receiving module 10, a processing module 20, and an output module 30.

When running a business, accounts receivable and payable would be produced between various organization units and/or collaborating agents. Each of the organization units or agents could be a paying party or a receiving party, and may have its own accounts receivable and payable systems. The automated centralized settlement system 1 provided by the present invention is a common platform among these accounts receivable and payable systems for automated settlement among the organization units and the agents. Therefore, the various accounts receivable systems 2 and the accounts payable systems 3 are all coupled to the automated centralized settlement system 1 so that all settling processes are carried out in the automated centralized settlement system 1. In FIG. 1, only one accounts receivable system 2 and one accounts payable system 3 are shown but there could be more, depending on the number of organization units and agents. The accounts receivable systems 2 and the accounts payable systems 3 could be independent or they are integrated in an Enterprise Resource Planning (ERP) system.

The receiving module 10 is for the reception of accounts receivable data from a receiving party via an accounts receivable system 2, and of accounts payable data from a paying party via an accounts payable system 3. As explained, the so-called receiving party and paying party could be an enterprise's organization unit or an agent collaborating with the enterprise. In other words, the respective accounts receivable and payable systems 2 and 3 of these organization units and agents could automatically send the accounts receivable and payable data to the automated centralized settlement system 1. Subsequently, the processing module 20 produces balance data from the accounts receivable and payable data, and the balance data is output by the output module 30.

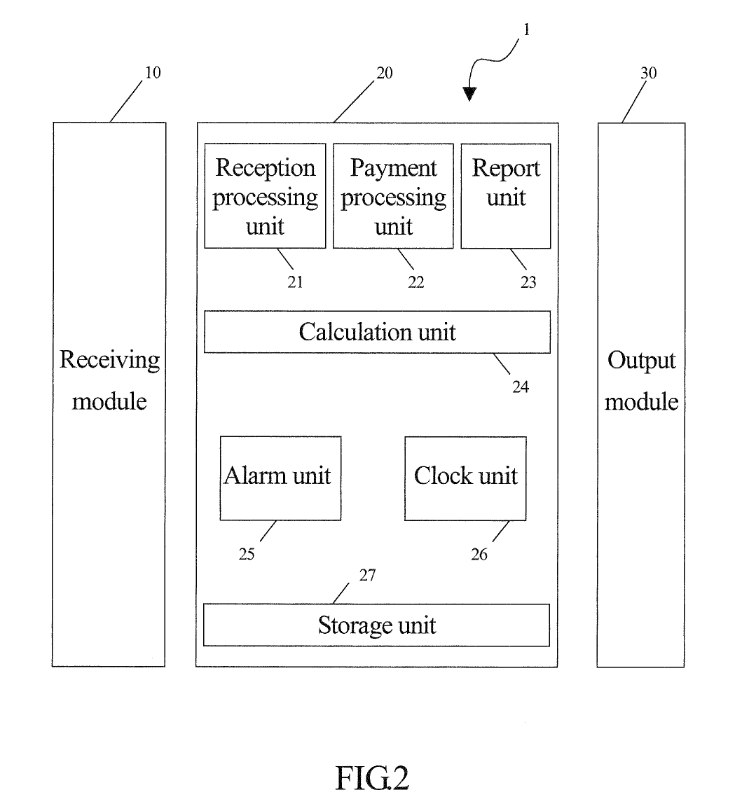

FIG. 2 is a schematic diagram showing the details of the processing module 20 of the automated centralized settlement system 1. As illustrated, the processing module 20 contains a reception processing unit 21, a payment processing unit 22, a report unit 23, a calculation unit 24, an alarm unit 25, a clock unit 26, and a storage unit 27.

The reception processing unit 21 is to handle the accounts receivable data and all accounts receivable remittances are posted here. The payment processing unit 22 is to handle accounts payable data and all accounts payable remittances are posted here. The report unit 23 is to produce various reports based on the accounts receivable and payable data for the utilization of the receiving party, the paying party, and the system administrator.

The calculation unit 24 calculates and produces balance data from the accounts receivable and payable data according to business logic. The so-called business logic could be based on general accounting principle or some self-defined accounting formulation. Each balance data entry contains a net amount between corresponding accounts receivable and payable data entries. The output module 30 then delivers each balance data entry to corresponding accounts receivable and payable systems 2 and 3.

The alarm unit 25 would produce an alarm message if the corresponding accounts receivable and payable data is of different currencies. The automated centralized settlement system 1 is configured with a default currency (e.g., US dollar). When an accounts receivable or payable data is of a different currency, the alarm unit 25 would produce and sends an alarm message to the corresponding receiving or paying party, so as to inform the receiving or paying party to conduct currency exchange and the exchange rate to use. The receiving or paying party could determine if it agrees with the specified exchange rate. If it agrees, the processing continues; otherwise, the settlement is aborted.

The clock unit 26 is to keep track of time so that the automated centralized settlement system 1 would automatically perform settlement processes once every a period of time. For example, if the period is a month, the automated centralized settlement system 1 would carry out the settlement processes each month so as to save the overhead (e.g., wire transfer fees) of the receiving and paying parties.

The storage unit 27 is to store the accounts receivable and payable data and the balance data, along with the various logs for the interaction between the accounts receivable and payable systems 2 and 3, and the automated centralized settlement system 1. As such, a system administrator could easily retrieve all settlement-related history records from the storage unit 27.

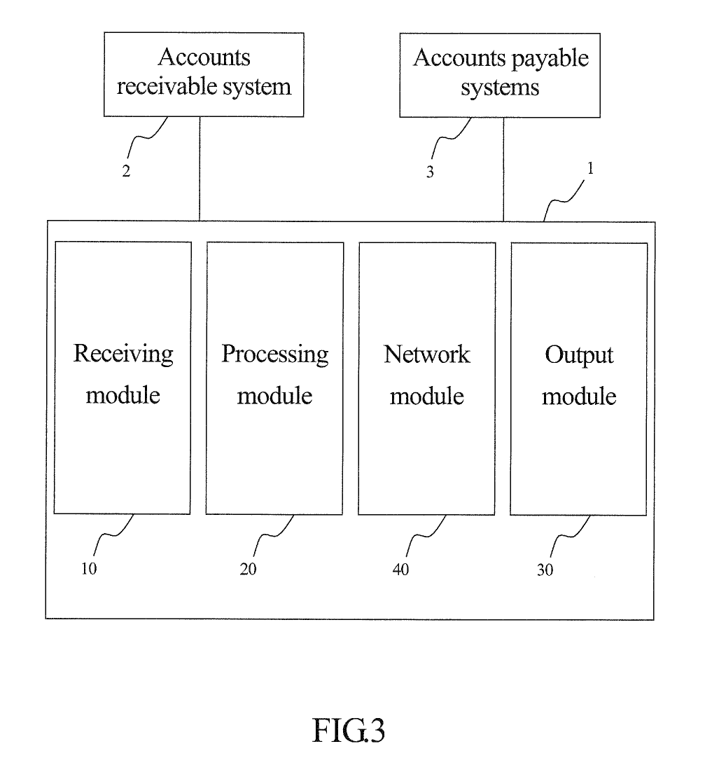

FIG. 3 is a schematic diagram showing an automated centralized settlement system according to another embodiment of the present invention. As illustrated, the automated centralized settlement system 1 contains an additional network module 40.

The network module 40 is to allow the receiving and paying parties to communicate over Internet. Conventionally, when they have differences, the receiving and paying parties have to rely on emails or telephones. The network module 40 provides another two-way communication means. When both parties require communications, they could post communication messages such as questions, exchange rates, etc. in a web page. Alternatively, the communication messages could be delivered by Instant Messaging (IM) means to speed up the communication process, thereby enhancing the settlement speed.

In addition, the network module 40 could deliver electronic invoices to the paying parties, thereby saving the postage and delivery time. By the on-line transmission of electronic invoices, the transmission records could be automatically stored in the automated centralized settlement system 1 for future examination and retrieval.

As described above, the automated centralized settlement system 1 is a common platform among the receiving and paying parties where their accounts receivable and payable data are centralized and processed and balance data is produced. The balance data is then distributed to corresponding accounts receivable and payable systems 2 and 3 for the cancellation of outstanding entries. As such, the error rate and cost of manual processing could be significantly reduced.

Further more, the automated centralized settlement system 1's network module 40 allows the receiving and paying parties to query and confirm various transactions, to communicate, and to transmit electronic invoice through a web page. As such, the receiving and paying parties could check processing status at any time, and the system administrator could monitor transaction status among organization units and agents, and to examine history records at any time.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An automated centralized settlement system coupled to an accounts receivable system and an accounts payable system, comprising:
a receiving module for the reception of accounts receivable data from a receiving party via said accounts receivable system, and of accounts payable data from a paying party via said accounts payable system;
a processing module producing balance data from said accounts receivable data and said accounts payable data; and
an output module where said balance data is output.

2. The automated centralized settlement system according to claim 1, wherein each of said receiving party and said paying party is one of an organization unit of an enterprise and an agent of said enterprise.

3. The automated centralized settlement system according to claim 1, wherein said processing module comprising:
a reception processing unit handling said accounts receivable data;
a payment processing unit handling said accounts payable data;
a report unit producing a corresponding report from said accounts receivable and payable data
a calculation unit calculating and producing balance data from said accounts receivable and payable data according to a business logic;
an alarm unit producing an alarm message if said corresponding accounts receivable and payable data is of different currencies;
a clock unit keeping track of time and triggering said automated centralized settlement system to perform settlement processes at periodic intervals; and
a storage unit storing said accounts receivable and payable data and said balance data, along with various logs for the interaction between said accounts receivable and payable systems, and said automated centralized settlement system.

4. The automated centralized settlement system according to claim 1, further comprising a network module providing a web page allowing said receiving and paying parties to query said accounts receivable and payable data, and said balance data.

5. The automated centralized settlement system according to claim 4, wherein said receiving and paying parties communicate with each other over Internet through said network module.

6. The automated centralized settlement system according to claim 4, wherein said receiving party transmits an electronic invoice to said paying party via said network module.

7. The automated centralized settlement system according to claim 1, wherein an entry of said balance data contains a net amount between corresponding entries of said accounts receivable and payable data; and said output module transmits said net amount to corresponding accounts receivable and payable systems.

8. The automated centralized settlement system according to claim 1, wherein said accounts receivable and payable systems are integrated in an Enterprise Resource Planning (ERP) system.
